(19) United States
(12) Patent Application Publication
(10) Pub. No.: US 2025/0297934 A1
(43) Pub. Date: Sep. 25, 2025

(54) APPARATUS FOR MEASURING VISCOELASTIC PROPERTIES OF AN ADHESIVE FILM FOR THERMAL COMPRESSION BONDING AND METHOD OF MEASURING VISCOELASTIC PROPERTIES OF AN ADHESIVE FILM USING THE SAME

(71) Applicant: Samsung Electronics Co., Ltd., Suwon-si (KR)

(72) Inventors: Yeonseop YU, Suwon-si (KR); Yunhwan KIM, Suwon-si (KR)

(73) Assignee: Samsung Electronics Co., Ltd., Suwon-si (KR)

(21) Appl. No.: 18/909,110

(22) Filed: Oct. 8, 2024

(30) Foreign Application Priority Data
Mar. 21, 2024 (KR) 10-2024-0038931

(51) Int. Cl. G01N 11/00

(52) U.S. Cl. CPC G01N 11/00

(57) ABSTRACT

An apparatus for measuring viscoelastic properties of an adhesive film may include a stage, a pressurizing head, a heater in the stage, a camera portion, and a thickness measurement sensor. The stage may have a mounting surface configured to support a lower die and an upper die attached to the lower die by an adhesive film and including a transparent material. The pressurizing head may be configured to pressurize the upper die onto the lower die. The heater may be configured to heat the adhesive film through the mounting surface. The camera portion may be configured to monitor a flow of the adhesive film between the upper die and the lower die when the upper die is pressurized by the pressurizing head. The thickness measurement sensor may be configured to measure a thickness change of the adhesive film when the upper die is pressurized by the pressurizing head.

### PRIORITY STATEMENT

This application claims priority under 35 U.S.C. § 119 to Korean Patent Application No. 10-2024-0038931, filed on Mar. 21, 2024 in the Korean Intellectual Property Office (KIPO), the contents of which are herein incorporated by reference in their entirety.

### BACKGROUND

### 1. Field

Example embodiments relate to an apparatus for measuring viscoelastic properties of an adhesive film for thermal compression bonding and a method of measuring viscoelastic properties of an adhesive film using the same. More particularly, example embodiments relate to an apparatus for measuring viscoelastic properties of a non-conductive film under thermal compression bonding conditions and a method of measuring viscoelastic properties of a non-conductive film using the same.

### 2. Description of the Related Art

In a process of stacking chips using thermal compression bonding, a non-conductive film may be used to ensure stable bonding characteristics of conductive bumps for connection between the chips. Since the thermal compression bonding may be performed under high heating rate and pressure, it may be required to measure a change in viscoelasticity including a viscosity of the non-conductive film with respect to temperature so as to achieve proper bonding of the conductive bumps. In case of measuring viscoelastic properties of the non-conductive film by using an actual thermal compression bonding apparatus, cost and time for equipment rental may increase, and a flowability of the non-conductive film may not be measured in real time. When measuring viscoelastic properties of the non-conductive film using a viscometer, such as a rheometer, there is a problem in that a heating rate of an actual thermal compression bonding process cannot be replicated.

### SUMMARY

Example embodiments provide a measuring apparatus that may measure viscoelastic properties of a non-conductive film in real time under thermal compression bonding process conditions.

Example embodiments provide a method of measuring viscoelastic properties of the non-conductive film by using the above-mentioned measuring apparatus.

According to an example embodiment, an apparatus for measuring viscoelastic properties of an adhesive film may include a stage having a mounting surface, the stage being configured to support a lower die on the mounting surface of the stage and an upper die attached to the lower die by an adhesive film, the upper die including a transparent material; a pressurizing head configured to pressurize the upper die onto the lower die; a heater in the stage and configured to heat the adhesive film through the mounting surface; a camera portion configured to monitor a flow of the adhesive film between the upper die and the lower die when the upper die is pressurized by the pressurizing head; and a thickness measurement sensor configured to measure a thickness change of the adhesive film when the upper die is pressurized by the pressurizing head.

According to an example embodiment, an apparatus for measuring viscoelastic properties of an adhesive film may include a stage having a mounting surface and a heater in the stage, the stage being configured to support a lower die on the mounting surface of the stage and an upper die attached to the lower die by an adhesive film, the heater being configured to apply heat to the lower die through the mounting surface; a pressurizing head configured to pressurize the upper die onto the lower die; and a camera portion configured to monitor a flow of the adhesive film between the upper die and the lower die when the upper die is pressurized by the pressurizing head.

According to an example embodiment, an apparatus for measuring viscoelastic properties of an adhesive film may include a stage having a mounting surface and a heater, the stage being configured to support a lower die on the mounting surface of the stage and an upper die attached to the lower die by an adhesive film, the heater including a heating line in the stage and configured to apply heat to the lower die through the mounting surface; a pressurizing head configured to pressurize the upper die onto the lower die; a camera portion configured to monitor a flow of the adhesive film between the upper die and the lower die when the upper die is pressurized by the pressurizing head; and a thickness measurement sensor above the stage and configured to measure a thickness change of the adhesive film when the upper die is pressurized by the pressurizing head.

According to an example embodiment, a method of measuring viscoelastic properties of an adhesive film may include placing a lower die on a stage; bonding an upper die onto the lower die using an adhesive film; pressurizing the upper die onto the lower die; measuring a thickness change of the adhesive film when the upper die is pressurized; and capturing an image of the adhesive film using a camera when the upper die is pressurized.

According to an example embodiment, an apparatus for measuring viscoelastic properties of an adhesive film may include a stage configured to support a die stack including an upper die bonded on a lower die by an adhesive film, a first heater provided in the stage and configured to heat the adhesive film, a pressurizing head configured to pressurize the upper die onto the lower die, a camera portion configured to detect a flowability of the adhesive film between the upper die and the lower die when the upper die is pressurized by the pressurizing head, and a thickness measurement sensor configured to measure a change in thickness of the adhesive film when the upper die is pressed by the pressurizing head.

The apparatus for measuring viscoelastic properties of an adhesive film may measure properties such as viscosity, flowability, etc. of the adhesive film between bonded dies in real-time by providing process conditions that simulate actual thermal compression bonding conditions. Accordingly, viscosity changes and flowability of the adhesive film may be measured under temperature and pressure conditions during a process time, an optimal range suitable for solder melting may be determined, and may be used to design process conditions for thermal compression bonding. Thus, it may be possible to accurately measure viscoelastic properties of the adhesive film and to measure a flowability of the adhesive film in real time by simulating actual thermal compression bonding conditions at a low cost.

### BRIEF DESCRIPTION OF THE DRAWINGS

Example embodiments will be more clearly understood from the following detailed description taken in conjunction with the accompanying drawings. FIGS. 1 to 9 represent non-limiting, example embodiments as described herein.

FIG. 1 is a cross-sectional view illustrating an apparatus for measuring viscoelastic properties of an adhesive film in accordance with example embodiments.

FIG. 2 is an image illustrating an adhesive film between an upper die and a lower die captured by a camera portion.

FIG. 3 is a block diagram illustrating a thickness measurement sensor in FIG. 1.

FIGS. 4A, 4B and 4C are cross-sectional views illustrating a solder bonding process in thermal compression bonding.

FIG. 5 is a graph illustrating a viscosity change of a non-conductive film with respect to temperature in a thermal compression bonding process.

FIG. 6A is a graph illustrating a heating rate of an adhesive film over time.

FIG. 6B is a graph illustrating a pressure change of an adhesive film over time.

FIG. 6C is a graph illustrating a height change of an adhesive film over time.

FIG. 6D is a graph illustrating a viscosity change of an adhesive film over time.

FIG. 7 is a graph illustrating a viscosity change of an adhesive film over time at different heating rates.

FIG. 8 is a cross-sectional view illustrating an apparatus for measuring viscoelastic properties of an adhesive film in accordance with different example embodiments.

FIG. 9 is a flowchart illustrating a method of measuring viscoelastic properties of an adhesive film.

### DETAILED DESCRIPTION OF EXAMPLE EMBODIMENTS

Hereinafter, example embodiments will be explained in detail with reference to the accompanying drawings.

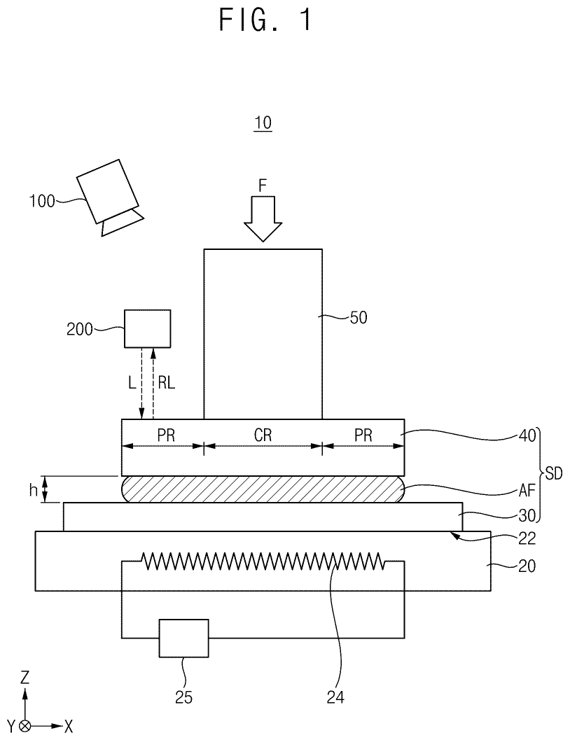

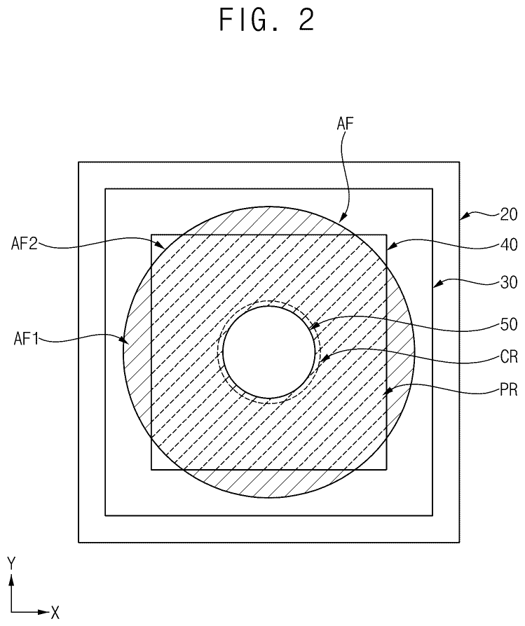

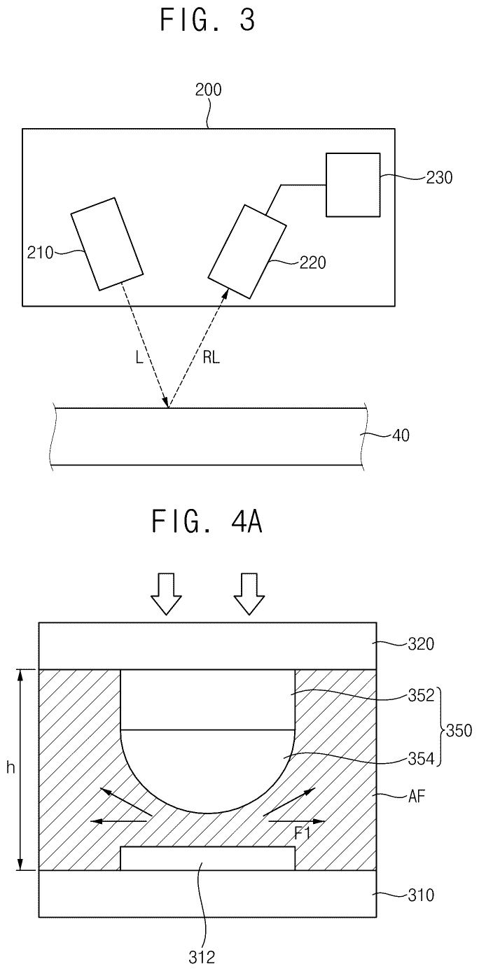

FIG. 1 is a cross-sectional view illustrating an apparatus for measuring viscoelastic properties of an adhesive film in accordance with example embodiments. FIG. 2 is an image illustrating an adhesive film between an upper die and a lower die captured by camera portion. FIG. 3 is a block diagram illustrating a thickness measurement sensor in FIG. 1.

Referring to FIGS. 1 to 3, a viscoelasticity measuring apparatus for an adhesive film 10 may include a stage 20, a lower die 30 and an upper die 40 facing each other with an adhesive film AF interposed therebetween, a pressurizing head 50, a camera portion 100, and a thickness measurement sensor 200. In addition, the viscoelasticity measuring apparatus 10 may further include a controller that is connected to the stage 20, the camera portion 100, and the thickness measurement sensor 200 to control their operations.

In example embodiments, the viscoelasticity measuring apparatus 10 may be a monitoring apparatus that is configured to measure viscoelastic properties of the adhesive film AF between the lower die 30 and the upper die 40 in real time under thermal compression bonding process conditions.

As illustrated in FIG. 1, the stage 20 may be provided with a mounting surface 22 on which the lower die 30 may be supported. The stage 20 may support a stack die structure SD that includes the upper die 40 bonded to the lower die 30 by the adhesive film AF. For example, suction holes for vacuum suction of the lower die 30 may be formed in the mounting surface 22 of the stage 20, and the lower die 30 may be vacuum suctioned and supported on the mounting surface 22 of the stage 20. The adhesive film AF may be attached to one surface of a wafer that includes the upper die 40, and the wafer may be cut to form the individualized upper die 40, and the upper die 40 may be attached to the lower die 30 using the adhesive film AF.

The upper die 40 may have a shape the same as a semiconductor chip that is an object to be actually bonded. The lower die may have a shape the same as a wafer or a package substrate to which the semiconductor chip is bonded.

For example, the lower die 30 may include a substrate that contains or includes silicon. The upper die 40 may be a transparent substrate that includes a transparent material such as a glass substrate. The adhesive film AF may include a thermosetting resin. The adhesive film AF may include a polymer material that contains or includes inorganic fillers. The adhesive film AF may include a non-conductive film NCF.

The stage 20 may be installed to be movable in at least one direction. The viscoelasticity measuring apparatus 10 may include a stage driver (e.g., motor), and the stage driver may move the stage 20 in X and Y directions in response to a control signal from the controller. A moving speed of the stage 20 may be controllable.

In example embodiments, the viscoelasticity measuring apparatus 10 may include a first heater 24 that is provided in the stage 20 and is configured to heat the adhesive film AF through the mounting surface 22. The first heater 24 may include an electric resistance heating wire as a heating line. The electric resistance heating wire may be electrically connected to a first power supply 25 (e.g., power supply circuit). The first power supply 25 may control a current that is flowing through the electric resistance heating wire according to the control signal from the controller. Accordingly, the first heater 24 may control a heating rate of the adhesive film AF. The first heater 24 may heat the adhesive film AF at a rate of at least 50° C./s. For example, the first heater 24 may heat the adhesive film AF at a rate of 100° C./s or a heating rate in a range of 50° C./s to 120° C./s, but is not limited thereto.

In example embodiments, the pressurizing head 50 may pressurize the upper die 40 to the lower die 30. The pressurizing head 50 may include a weighing mechanism (e.g., cylindrical head block movable via a robotic arm) to pressurize the upper die 40 with desired constant weights. Alternatively, the pressurizing head 50 may include a hydraulic device to vary a pressure on the upper die 40 during pressurizing.

The upper die 40 may include a central region CR and a peripheral region PR surrounding the central region CR. The pressurizing head 50 may press into contact with the upper die 40. For example, a pressing portion of the pressurizing head 50 that makes contact with the upper die 40 may have a circular cross-sectional shape. The pressure head 50 may overlap the central region CR of the upper die 54. If the pressurizing head 50 has the weighing mechanism, a cylindrical weight may be placed on the central region CR of the upper die 54. Accordingly, the peripheral region PR of the upper die 40 may be exposed by the pressurizing head 50.

In example embodiments, the camera portion 100 may include at least one camera to observe a flow of the adhesive film AF between the upper die 40 and the lower die 30 when the upper die 40 is pressed onto the lower die 30 by the pressurizing head 50. The upper die 40 may include the transparent material, and the camera may capture the adhesive film AF through the peripheral region PR of the upper die 40 exposed by the pressurizing head 50. The camera may be provided above the upper die 40 and may capture real-time images of a spreading pattern of the adhesive film AF through the transparent upper die 40, to obtain images of the adhesive film AF. The camera may be installed to be movable in X direction or Y direction over the stage 20. Additionally, the camera may be installed to be movable in Z direction over the stage 20.

As illustrated in FIG. 2, when the first heater 24 heats the adhesive film AF at a constant heating rate and the pressurizing head 50 pressurizes the upper die 40 onto the lower die 30, the adhesive film AF may be liquefied and have fluidity due to viscosity changes, and may flow between the lower die 30 and the upper die 40 and then may be cured. First portions AF1 of the adhesive film AF may be fillet portions (e.g., overflow portions) protruding from four sides of the upper die 40. Second portions of the adhesive film AF2 may not completely cover four corners of the upper die 40, and accordingly, unfilled portions may be formed at these corners. By analyzing images obtained by the camera, a protruding length of the fillet portion and a length of the unfilled portion may be measured. By analyzing images obtained by the camera, voids generated in the adhesive film AF may be detected.

In example embodiments, the thickness measurement sensor 200 may measure a change in a thickness of the adhesive film when the upper die 40 is pressurized onto the lower die 30 by the pressurizing head 50. The thickness measurement sensor 200 may include a non-contact sensor using light. When the upper die 40 is pressurized, the thickness measurement sensor 200 may measure a thickness of the adhesive film AF by detecting a change in a spacing distance between the upper die 40 and the sensor 200.

As illustrated in FIG. 3, the thickness measurement sensor 200 may include an optical irradiation portion 210 that irradiates light L to the upper die 40, an optical detection portion 220 that detects a light RL reflected from the upper die 40, and a signal processor 230 that calculates a thickness h of the adhesive film AF using a detected optical signal from the detection portion 220. For example, the optical irradiation portion 210 may include a laser diode to emit laser light L and a focusing lens to concentrate the laser onto the adhesive film AF. The optical detection portion 220 may include a CCD camera, and a laser light reflected from a surface of the upper die 40 may be imaged on an imaging surface of the CCD camera, and the signal processor 230 may calculate the thickness h of the adhesive film AF using an optical triangulation method.

As mentioned above, the viscoelasticity measuring apparatus 10 may include the stage 20 configured to support the die stack including the upper die 40 bonded on the lower die 30 by the adhesive film AF, the first heater 24 provided in the stage 20 and configured to heat the adhesive film AF, the pressurizing head 50 configured to pressurize the upper die 40 onto the lower die 30, the camera portion 100 configured to detect a flowability of the adhesive film AF between the upper die 40 and the lower die 30 when the upper die 40 is pressurized by the pressurizing head 50, and the thickness measurement sensor 200 configured to measure a change in thickness of the adhesive film AF when the upper die 40 is pressed by the pressurizing head 50.

The viscoelasticity measuring apparatus 10 may simulate a die-to-wafer bonding apparatus and measure properties such as viscosity, flowability, etc. of the adhesive film AF between bonded dies in real-time. In addition, the viscoelasticity measuring apparatus 10 may measure the viscosity change and flowability of the adhesive film AF under temperature and pressure conditions during a process time to determine an optimal range suitable for solder melting and the determined optical range may be used to design process conditions for a thermal compression bonding process. A thermal compression bonding process may be performed based on the optimal range determined by the viscoelasticity measuring apparatus 10.

Hereinafter, solder bonding stages in a thermal compression bonding process and a change in viscosity of a non-conductive film according to temperature will be described.

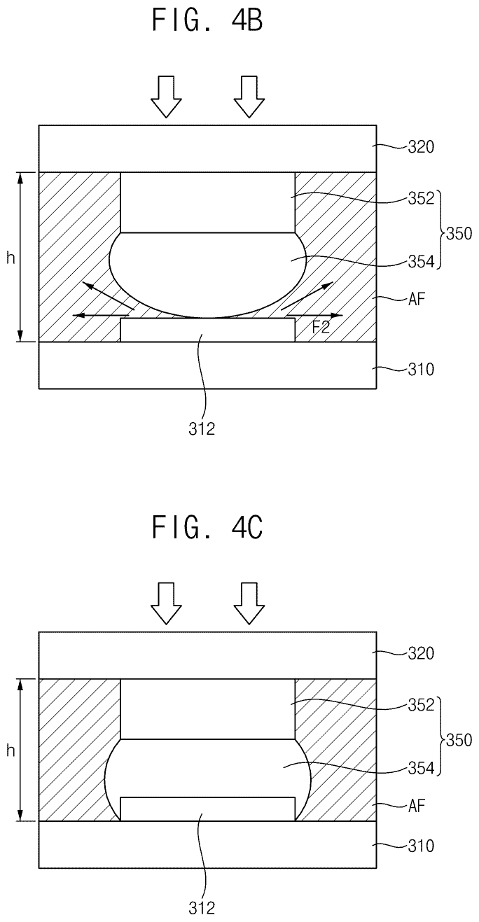

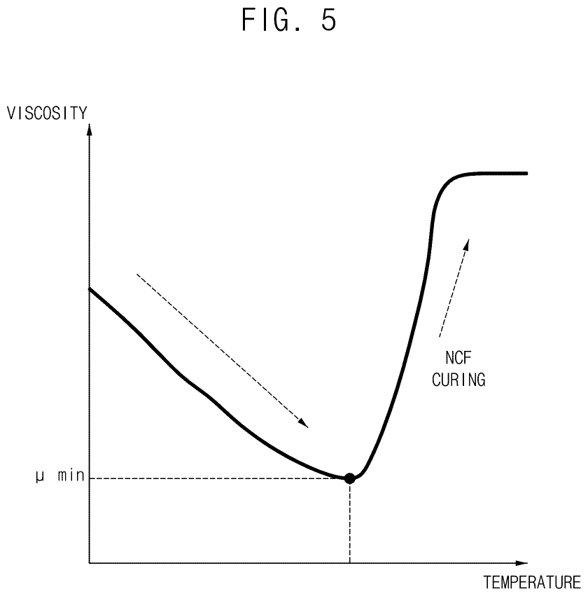

FIGS. 4A to 4C are cross-sectional views illustrating solder bonding stages in a thermal compression bonding process. FIG. 5 is a graph illustrating a viscosity change of a non-conductive film with respect to temperature in a thermal compression bonding process.

As illustrated in FIG. 4A, first, a wafer 310 including a plurality of lower dies formed therein may be loaded onto a stage of a bonding apparatus, and a bonding head of the bonding apparatus may pick up an upper semiconductor chip 320 that has been individualized through a sawing process and may place it on the corresponding lower die of the wafer 310. Here, a plurality of conductive bumps 350 may be formed on a lower surface of the upper semiconductor chip 320, and a non-conductive film AF may be attached to the lower surface of an upper semiconductor chip 320 to cover the plurality of conductive bumps 350. For example, each of the conductive bumps 350 may include a pillar bump 352 formed on a chip pad of the upper semiconductor chip 320 and a solder bump 354 formed on the pillar bump 352.

Then, the bonding head may heat and pressurize the upper semiconductor chip 320 to attach the non-conductive film AF onto the wafer 310. As a temperature rises and pressure continues to be applied by the bonding head, a viscosity of the non-conductive film AF may decrease sharply such that the non-conductive film AF has fluidity, and accordingly, as the upper semiconductor chip 320 descends, the solder bump 354 may push the non-conductive film AF aside, so that the non-conductive film AF spreads at a first flow rate (F1).

As illustrated in FIG. 4B, as the upper semiconductor chip 320 continues to descend, the solder bump 354 may eventually come into contact with a bonding pad 312 of the lower die. At this time, the non-conductive film AF may spread at a second flow rate (F2). When the viscosity of the non-conductive film AF is lowered to a desired value, the solder bumps 354 may push the non-conductive film AF aside and make contact with the bonding pad 312.

As illustrated in FIG. 4C, when the solder bump 354 reaches its melting point (e.g., 221° C.), the solder bump may be melted and bonded to the bonding pad 312.

Referring to FIG. 5, as a temperature rises, a viscosity of the non-conductive film AF may decrease and have fluidity, and then, as the temperature rises to pass the lowest point (μmin) of the viscosity, the non-conductive film AF may harden and the viscosity may increase rapidly. Accordingly, by measuring the change in viscosity of the non-conductive film with respect to temperature, the thermal compression process conditions may be designed such that melting of the solder bump occurs near the lowest viscosity point.

Hereinafter, a method of measuring a change in viscosity of the adhesive film according to conditions of the thermal compression bonding process using the viscoelasticity measuring apparatus of FIG. 1 will be described.

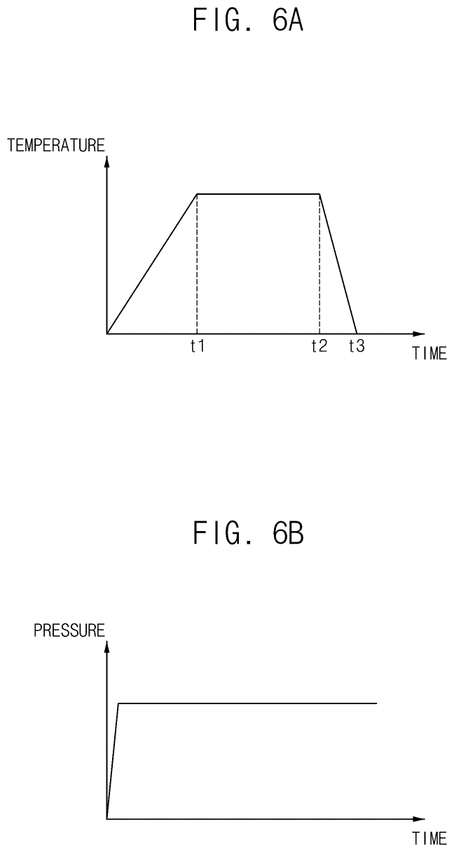

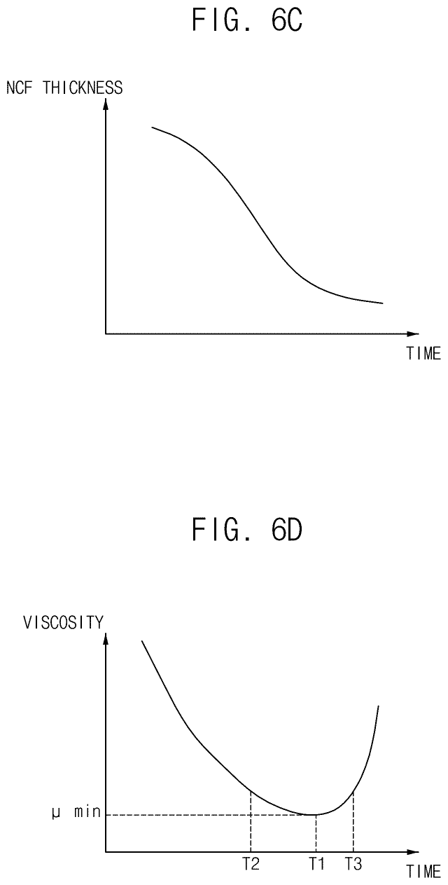

FIG. 6A is a graph illustrating a heating rate of an adhesive film over time, FIG. 6B is a graph illustrating a pressure change of an adhesive film over time, FIG. 6C is a graph illustrating a height change of an adhesive film over time, and FIG. 6D is a graph illustrating a viscosity change of an adhesive film over time.

Referring to FIGS. 6A to 6D, the first heater 24 of the viscoelasticity measuring apparatus 10 may heat the adhesive film AF at a temperature increase rate (heating rate) in an actual thermal compression bonding process.

For example, temperature of the first heater 24 may be increased at a constant temperature increase rate (e.g., 100° C./s) during a first time section (0 to t1), and the temperature of the first heater 24 may be kept constant during a second time section (t1 to t2), and the temperature of the first heater 24 may be reduced during a third time section (t2 to t3). The pressurizing head 50 may pressurize the upper die 40 with a constant weight.

A thickness of the adhesive film AF measured by the thickness measurement sensor 200 decreases over time, and the signal processor 230 may calculate a viscosity of the adhesive film AF from a change in thickness of the adhesive film AF. For example, a viscosity between two parallel disks may be calculated by Equation (1) below.

$$μ = \frac{[ \frac{8}{3} ( {F}_{z} - {P}_{R} π {R}^{2} ) - 4 \frac{d h}{d t} π {R}^{2} \frac{1}{h} ]}{[ \frac{d h}{d t} π {R}^{2} \frac{1}{h 3} ]} \qquad Equation ( 1 )$$

Here, μ is a viscosity, Fz is pressure, PR is atmospheric pressure, h is a height of the adhesive film, dh/dt is a rate of change in height over time, and R is a radius of the adhesive film.

As illustrated in FIG. 6D, if a solder is melted at a second time (T2) before the lowest viscosity point (μmin), the adhesive film AF remaining on the solder surface may have low fluidity and may not spread sufficiently to the side, so the adhesive film AF may limit and/or prevent the bonding between the solder and the bonding pad. On the other hand, if the solder melts at a third time (T3) after the lowest viscosity point (μmin), the adhesive film AF may have a higher fluidity and may push the solder away, causing deformation of the solder.

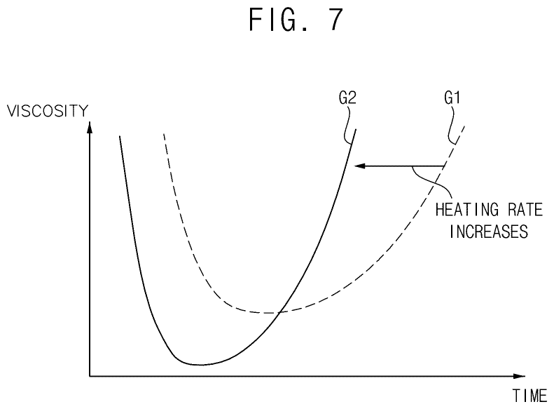

FIG. 7 is a graph illustrating a viscosity change of an adhesive film over time at different heating rates.

Referring to FIG. 7, graph G1 shows a change in viscosity of the adhesive film over time at a first heating rate, and graph G2 shows a change in viscosity of the adhesive film over time at a second heating rate that is greater than the first heating rate. It can be seen that as the heating rate increases, the lowest viscosity point decreases.

The viscoelasticity measuring apparatus 10 for an adhesive film may provide changes in viscosity of a non-conductive film AF under an actual thermal compression process conditions. Accordingly, the optimal viscosity range of the non-conductive film AF may be determined by analyzing and comparing the viscosity behavior of the non-conductive film AF and the melting point of the solder.

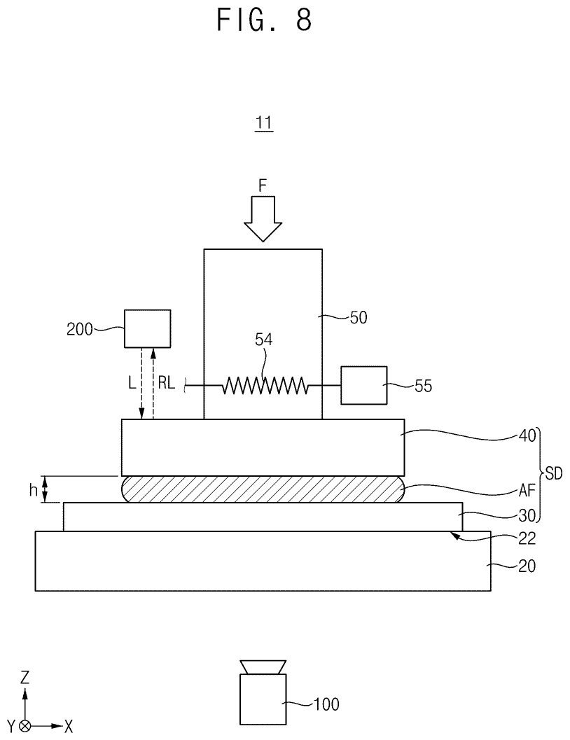

FIG. 8 is a cross-sectional view illustrating an apparatus for measuring viscoelastic properties of adhesive film in accordance with example embodiments. The viscoelasticity measuring apparatus is substantially the same as or similar to the apparatus for measuring viscoelastic properties of adhesive film described with reference to FIG. 1 except for a configuration of a lower die, an arrangement of a camera, and an additional second heater. Thus, same reference numerals will be used to refer to the same or like elements and any further repetitive explanation concerning the above elements will be omitted.

Referring to FIG. 8, a viscoelasticity measuring apparatus 11 may include a stage 20, a lower die 30 and an upper die 40 facing each other with an adhesive film AF interposed therebetween, a pressurizing head 50, a camera portion 100, and a thickness measurement sensor 200.

In example embodiments, the apparatus for measuring viscoelastic properties 11 may include a second heater 54 that is provided in the pressurizing head 50 and is configured to heat the adhesive film AF through the upper die 40. The second heater 54 may include an electric resistance heating wire as a heating line. The electric resistance heating wire may be electrically connected to a second power supply 55. The second power supply 55 may adjust a current that is flowing through the electric resistance heating wire according to a control signal from a controller. Accordingly, the second heater 54 may control a heating rate of the adhesive film AF. The second heater 54 may heat the adhesive film AF at a heating rate of an actual thermal compression bonding process. For example, The first heater 24 may heat the adhesive film AF at a rate of 50° C./s.

In this case, the viscoelasticity measuring apparatus 11 may further include a first heater that is provided in the stage 20 and is configured to heat the adhesive film AF through a mounting surface 22 of the stage 20. Alternatively, the first heater may not be provided inside the stage 20.

In example embodiments, the lower die 30 may be a transparent substrate that includes a transparent material such as a glass substrate. The camera portion 100 may be provided below the lower die 30 and may capture the adhesive film through the transparent lower die 30.

In this case, at least one camera of the camera portion 100 may be placed below the stage 20. The stage 20 may include a transparent window for transmitting light therethrough, and the camera may capture the adhesive film AF through the transparent window and the lower die 30.

Hereinafter, a method of measuring viscoelastic properties of an adhesive film by using the viscoelasticity measuring apparatus of FIG. 1 or FIG. 8 will be described.

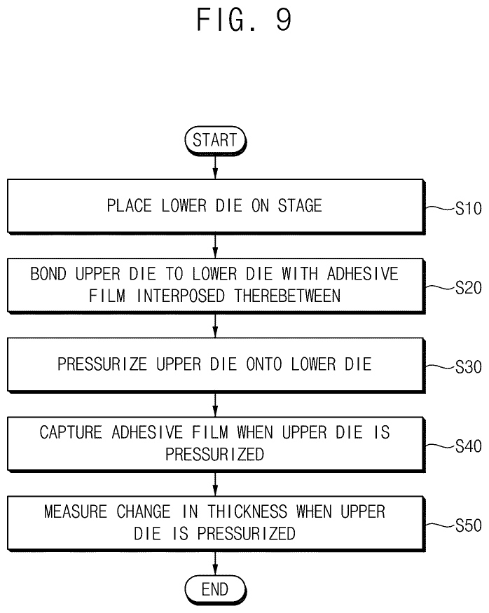

FIG. 9 is a flowchart illustrating a method of measuring viscoelastic properties of an adhesive film in accordance with example embodiments.

Referring to FIGS. 1, 2, 3, 8 and 9, firstly, a lower die 30 may be placed on a stage 20 (S10), and an upper die 40 may be bonded to the lower die 30 with an adhesive film AF interposed therebetween (S20).

In example embodiments, suction holes for vacuum suction of the lower die 30 may be formed in a mounting surface 22 of the stage 20, and the lower die 30 may be vacuum suctioned and supported on the mounting surface 22 of the stage 20. The adhesive film AF may be attached to one surface of a wafer that includes the upper die 40, and the wafer may be cut to form the individualized upper die 40, and the upper die 40 may be attached to the lower die 30 using the adhesive film AF. Alternatively, the upper die 40 may be attached to the lower die 30 by using the adhesive film AF to form a stacked die structure (SD), and the stacked die structure (SD) may be placed on the mounting surface 22 of the stage 20.

The upper die 40 may have a same shape as a semiconductor chip to be actually bonded. The lower die 30 may have a same shape as a wafer or a package substrate to which a semiconductor chip is bonded.

For example, the lower die 30 may include a substrate that contains or includes silicon. The upper die 40 may be a transparent substrate that includes a transparent material such as a glass substrate. The adhesive film AF may include a thermosetting resin. The adhesive film AF may include a polymer material that contains inorganic fillers. The adhesive film AF may include a non-conductive film NCF.

Then, the upper die 40 may be pressurized onto the lower die 30 (S30), and the adhesive film AF may be heated at a desired and/or alternatively predetermined heating rate.

In example embodiments, a pressurizing head 50 may pressurize the upper die 40 onto the lower die 30. The pressurizing head 50 may include a weighing mechanism to pressurize the upper die 40 with desired constant weights. Alternatively, the pressurizing head 50 may include a hydraulic device to vary a pressure on the upper die 40 during pressurizing.

Power may be supplied to the first heater 24 provided in the stage 20 to heat the adhesive film AF through the mounting surface 20. The first heater 24 may include an electric resistance heating wire as a heating line. A first power supply 25 may control a current that is flowing through the electric resistance heating wire according to a control signal from a controller. Accordingly, the first heater 24 may control a heating rate of the adhesive film AF.

For example, temperature of the first heater 24 may be increased at a constant temperature increase rate (e.g., 100° C./s) during a first time section, and the temperature of the first heater 24 may be kept constant during a second time section, and a temperature of the first heater 24 may be reduced during a third time section. The pressurizing head 50 may pressurize the upper die 40 with a constant weight.

Then, when the upper die 40 is pressurized, the adhesive film AF may be captured by a camera (S40), and a change in thickness of the adhesive film AF may be measured (S50).

When the first heater 24 heats the adhesive film AF at a constant heating rate and the pressurizing head 50 pressurizes the upper die 40 onto the lower die 30, the adhesive film AF may be liquefied and may have fluidity due to viscosity changes, and may flow between the lower die 30 and the upper die 40 and then may be cured. A camera portion 100 may be provided above the upper die 40 and may capture real-time images of a spreading pattern of the adhesive film AF through the transparent upper die 40, to obtain images of the adhesive film AF. By analyzing the images obtained by the camera portion 100, protruding lengths of fillet portions that protrude from sides of the upper die 40 and a length of an unfilled portion at corners of the upper die 40 may be measured. In addition, by analyzing the images, voids generated in the adhesive film AF may be detected. If voids in the adhesive film AF are detected, then the process may be adjusted and/or reworked to limit and/or prevent voids in the adhesive film AF.

A thickness measurement sensor 200 may measure a change in thickness of the adhesive film when the upper die 40 is pressurized onto the lower die 30 by the pressurizing head 50. The thickness measurement sensor 200 of FIGS. 1 and 8 may be provided over the upper die 40 and may measure a thickness of the adhesive film AF by detecting changes in distance between the upper die 40 and the sensor 200.

The thickness measurement sensor 200 may include an optical irradiation portion 210 that irradiates light L to the upper die 40, an optical detection portion 220 that includes a CCD camera for capturing a laser light (RL) reflected from the upper die 40, and a signal processor 230 that calculates a thickness (h) of the adhesive film AF using detected optical signals. The thickness measurement sensor 200 may calculate the thickness (h) of the adhesive film AF by using an optical triangulation method. Alternatively, the thickness measurement sensor 200 may calculate a thickness (h) of the adhesive film AF using holography, confocal microscopy, etc.

As mentioned above, by providing conditions that simulate actual thermal compression bonding conditions, viscoelastic properties such as viscosity and flowability of the adhesive film between bonded dies may be measured in real time. In addition, during a process time, by measuring viscosity changes and flowability of the adhesive film under temperature and pressure conditions, an optimal range that is suitable for solder melting may be determined. This information may be used to design process conditions for thermal compression bonding.

One or more of the elements disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages of inventive concepts. Accordingly, all such modifications are intended to be included within the scope of example embodiments as defined in the claims.

1. An apparatus for measuring viscoelastic properties of an adhesive film, the apparatus comprising:
a stage having a mounting surface,
the stage being configured to support a lower die on the mounting surface of the stage and an upper die attached to the lower die by an adhesive film, the upper die including a transparent material;
a pressurizing head configured to pressurize the upper die onto the lower die;
a heater in the stage and configured to heat the adhesive film through the mounting surface;
a camera portion configured to monitor a flow of the adhesive film between the upper die and the lower die when the upper die is pressurized by the pressurizing head; and
a thickness measurement sensor configured to measure a thickness change of the adhesive film when the upper die is pressurized by the pressurizing head.

2. The apparatus of claim 1, wherein the heater is configured to heat the adhesive film at a heating rate of at least 50° C./s.

3. The apparatus of claim 1, wherein the adhesive film includes a thermosetting resin.

4. The apparatus of claim 1, wherein the adhesive film includes a non-conductive film.

5. The apparatus of claim 1, wherein the pressurizing head includes a weighing mechanism configured to pressurize the upper die with a constant weight.

6. The apparatus of claim 1, wherein
the camera portion is above the stage and configured to capture an image of the adhesive film through the upper die.

7. The apparatus of claim 1, wherein the thickness measurement sensor is above the stage and configured to measure a thickness of the adhesive film by measuring a distance from a surface of the upper die.

8. The apparatus of claim 1, wherein
a material in the lower die is transparent such that the lower die is a transparent lower die, and
the camera portion is below the stage and configured to capture an image of the adhesive film through the transparent lower die.

9. The apparatus of claim 1, wherein
the thickness measurement sensor includes an optical irradiation portion, an optical detector, and a signal processor,
the optical irradiation portion is configured to irradiate light to a surface of the upper die,
the optical detector is configured to detect light reflected from the upper die surface; and
the signal processor is configured to calculate a thickness of the adhesive film by using a light signal detected by the optical detector.

10. The apparatus of claim 9, wherein
the light includes a laser, and
the signal processor is configured to calculate a thickness of the adhesive film using optical triangulation.

11. An apparatus for measuring viscoelastic properties of an adhesive film, the apparatus comprising:
a stage having a mounting surface and a heater in the stage,
the stage being configured to support a lower die on the mounting surface of the stage and an upper die attached to the lower die by an adhesive film,
the heater being configured to apply heat to the lower die through the mounting surface;
a pressurizing head configured to pressurize the upper die onto the lower die; and
a camera portion configured to monitor a flow of the adhesive film between the upper die and the lower die when the upper die is pressurized by the pressurizing head.

12. The apparatus of claim 11, wherein the heater is configured to heat the adhesive film at a heating rate of at least 50° C./s.

13. The apparatus of claim 11, wherein the adhesive film includes a non-conductive film.

14. The apparatus of claim 11, wherein the pressurizing head includes a weighing mechanism configured to pressurize the upper die with a constant weight.

15. The apparatus of claim 11, wherein
the upper die includes a transparent material, and
the camera portion is above the stage and configured to capture an image of the adhesive film through the transparent upper die.

16. The apparatus of claim 11, wherein
the lower die includes a transparent material, and
the camera portion is below the lower die and configured to capture an image of the adhesive film through the transparent lower die.

17. The apparatus of claim 11, further comprising:
a thickness measurement sensor, wherein
the thickness measurement sensor is configured to measure a thickness change of the adhesive film when the upper die is pressurized by the pressurizing head.

18. The apparatus of claim 17, wherein the thickness measurement sensor includes:
an optical irradiation portion configured to irradiate light to a surface of the upper die;
an optical detector configured to detect light reflected from the upper die surface; and
a signal processor configured to calculate a thickness of the adhesive film using a light signal detected by the optical detector.

19. The apparatus of claim 18, wherein
the light includes a laser, and
the signal processor is configured to calculate a thickness of the adhesive film using optical triangulation.

20. An apparatus for measuring viscoelastic properties of an adhesive film, the apparatus comprising:
a stage having a mounting surface and a heater,
the stage being configured to support a lower die on the mounting surface of the stage and an upper die attached to the lower die by an adhesive film,
the heater including a heating line in the stage and configured to apply heat to the lower die through the mounting surface;
a pressurizing head configured to pressurize the upper die onto the lower die;
a camera portion configured to monitor a flow of the adhesive film between the upper die and the lower die when the upper die is pressurized by the pressurizing head; and
a thickness measurement sensor above the stage and configured to measure a thickness change of the adhesive film when the upper die is pressurized by the pressurizing head.

21. (canceled)
